(19) United States
(12) Patent Application Publication
(10) Pub. No.: US 2012/0311501 A1
(43) Pub. Date: Dec. 6, 2012

(54) DISPLAYING GRAPHICAL OBJECT RELATIONSHIPS IN A WORKSPACE

(75) Inventors: Robert Nonez, Ottawa (CA); Alireza Pourshahid, Ottawa (CA); Graham Andrew Watts, Ottawa (CA)

(73) Assignee: International Business Machines Corporation, Armonk, NY (US)

(21) Appl. No.: 13/150,718

(22) Filed: Jun. 1, 2011

(51) Int. Cl. G06F 3/048

(52) U.S. Cl. 715/838

(57) ABSTRACT

Exemplary embodiments provide methods and systems performed by a software component executing on at least one processor for displaying graphical objects in a workspace. Aspects of the exemplary embodiment include displaying on a display screen a view showing a portion of graphical objects comprising the workspace; indicating a relationship in the view between a selected graphical object and one or more related graphical objects; in response to any of the one or more related graphical objects being outside of the view, displaying thumbnails within the view for each of the one or more related graphical objects to visually identify a type of content provided by the one or more related graphical objects; and in response to a user selecting one of the thumbnails, moving the view to display the corresponding related graphical object.

### BACKGROUND

Mashups and dashboards are workspaces that refer to web-based applications that mix data and/or applications from multiple sources such as Web sites. The terms Mashups and dashboards may be used interchangeable or in combination, e.g., “mashup dashboards.” Mashups and dashboards typically display graphical objects in the form of mini applications called widgets. A widget is a control element that provides a user with an interaction point for the manipulating a particular kind of data. When combined in an application, a widget holds data processed by the application and the available interactions on this data. Widgets typically present the data in a window or text box. Business intelligent dashboards and mashups can contain many different widgets with various levels of “connectedness”. Interacting with one widget can cause others to update and display new information. As the mashups become more complex it is very difficult to keep track of how interacting with each widget will affect the others in the mashup.

For example, business intelligence dashboards are often complex aggregations of many small reports, which together may represent information a user considers important to an area of their business. To work effectively and efficiently with the dashboard, a user has to be able to quickly find the information they seek. Visual recognition of the report the user needs is often the way the user quickly finds this information.

The problem of finding the desired widget may be further exacerbated by the fact that many mashups and dashboards are larger than the display area in which they are shown on a display screen. This can be either because there is too much information to display in the display area, or because the author of the mashup had a larger display or resolution available to them during creation of the mashup. With portable computing devices with smaller screens becoming more and more common, the range of display sizes any one mashup could be viewed on is becoming larger, creating the potential for users to increasingly encounter difficulties in finding hidden or out-of-view widgets.

### BRIEF SUMMARY

Exemplary embodiments provide methods and systems performed by a software component executing on at least one processor for displaying graphical objects in a workspace. Aspects of the exemplary embodiment include displaying on a display screen a view showing a portion of graphical objects comprising the workspace; indicating a relationship in the view between a selected graphical object and one or more related graphical objects; in response to any of the one or more related graphical objects being outside of the view, displaying thumbnails within the view for each of the one or more related graphical objects to visually identify a type of content provided by the one or more related graphical objects; and in response to a user selecting one of the thumbnails, moving the view to display the corresponding related graphical object.

### BRIEF DESCRIPTION OF SEVERAL VIEWS OF THE DRAWINGS

FIG. 1 is a logical block diagram illustrating an exemplary system environment for implementing one embodiment of a method for displaying graphical object relationships in a workspace, such as mashap.

FIG. 2 is a flow diagram illustrating one embodiment of an improved process for displaying graphical objects in mashup.

FIGS. 3A-3B are diagrams illustrating an exemplary mashup workspace.

### DETAILED DESCRIPTION

The exemplary embodiment relates to method and system for displaying graphical objects such as widgets in a workspace. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The exemplary embodiments provide improved methods and systems for displaying graphical objects, such as widgets, in a workspace, such as a mashup. The exemplary embodiments may utilize screen indications to mark widgets in the mashup that are connected to or related to a currently selected widget. For example, a line may be drawn from the selected widget to each of the other related widgets in the current view of the mashup. If the related widget appears off the display area, then the line may be drawn to the edge of the display area or view in the direction of the related widget. In addition a thumbnail of an out-of-view related widget may be displayed at the edge of the screen. In response to a user clicking on the thumbnail, the view of the mashup may scroll to the related widget, which automatically becomes the selected widget.

The exemplary embodiments thus provide users with feedback that aids the users in finding related objects within a two-dimensional space of a workspace, such as a mashup. The exemplary embodiments help identify relationships between those objects, e.g., by showing a connection between objects that display the same type of business report data. A thumbnail is also displayed corresponding to out-of-view objects to enable the user to directly visually identify content related to the currently selected widget without having to navigate to the out-of-view objects.

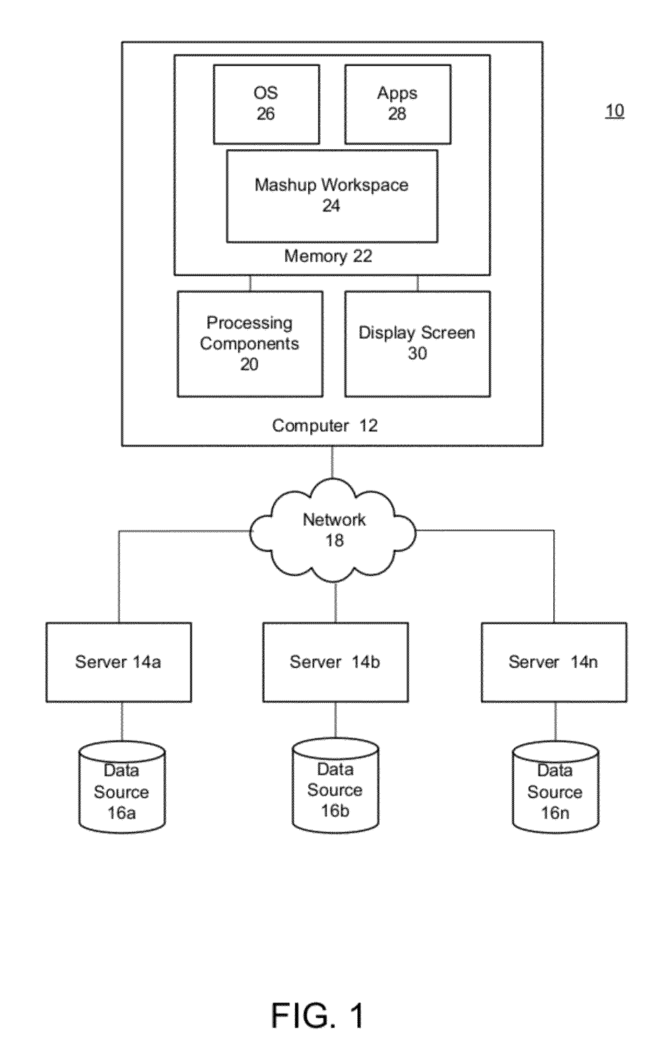

FIG. 1 is a logical block diagram illustrating an exemplary system environment for implementing one embodiment of a method for displaying graphical object relationships in a workspace. The system 10 may include a computer 12 that is capable of communicating with different servers 14a-14n to access different data sources 16a-16n over network 18. The network 18 may be a public network, such as the Internet, or a private network (such as an intranet), a LAN, a WLAN, or a WMAX, or a combination of thereof. In one embodiment, the servers 14a-14n may comprise any combination of Web servers and application servers.

The computer 12 may exist in various forms, including a personal computer (PC) (e.g., desktop, laptop, or notebook), a mobile phone, a tablet, a personal digital assistant (PDA), a set-top box, a game system, and the like. Both the servers 14a-14n and the computer 12 may include components of typical computing devices, including a processing components 20 coupled directly or indirectly to memory components through a system bus and memory (not shown). The processing components 20 may represent one or more processors and/or control logic, including ASICS and multi-core processors, for executing software components, such as mashup programs.

The memory components may include a local memory 22 employed during actual execution of the program code, bulk storage, and cache memories which provide temporary storage of at least some program code in order to reduce the number of times code must be retrieved from bulk storage during execution. The memory 22 may comprise any type of volatile or nonvolatile memory. Examples of volatile memory include random access memory (RAM) dynamic random access memory (DRAM) and static random access memory (SRAM). Examples of non-volatile memory include read-only memory, flash memory, ferroelectric RAM, most types of magnetic computer storage devices (e.g. hard disks, floppy disks, and magnetic tape), and optical discs. Both the volatile and non-volatile memory are considered herein as computer-readable media containing computer instructions that implement an embodiment of programs that display object relationships in a workspace when executed by at least one of the processing components 20.

Although not shown, the server 16 and the computers 12 may further include input devices (e.g., keyboard, pointing device, microphone for voice commands, buttons, touch screen, etc.), output devices (e.g., a display device). The input/output (I/O) devices can be coupled to the system either directly or through intervening I/O controllers. Network adapters may also be coupled to the processing elements 20 to enable the processing elements 20 to become coupled to other data processing systems or remote printers or storage devices through intervening private or public networks. Modems, cable modems and Ethernet cards are just a few of the currently available types of network adapters.

In one exemplary embodiment, the computer executes at least one software component, such as mashup program, that resides in memory 22 and is capable of displaying graphical objects representing data from different data sources 16a-16n in a workspace, such as mashup workspace 24. The mashup program may be implemented as part of an operating system (OS) 26, an application (app) 28. An example application 28 may comprise a browser that displays a mashup web page. As used herein, the mashup workspace 24 may combine data, presentation or functionality from two or more data sources 16a-16n to create new services, typically using open application programming interfaces (APIs).

In one embodiment, the mashup workspace 24 displays graphical objects, such as widgets, dashboard modules or a list of application thumbnails, on display screen 30 to provide the user with an interaction point for manipulating a particular kind of data. In one embodiment, the mashup workspace 24 may also provide a means of communication (usually through events) between widgets. Each widget may hold data processed by the application or other type of program and available interactions on this data. The widgets may be represented in the mashup workspace 24 as thumbnails, and the widgets may be considered as content applications that hold content from different sources. Through the widgets, the mashup may provide shared resources, software, and information to a user of the computer 12 on demand through the mashup workspace 24.

The mashup workspace 24 may contain many different widgets with various levels of connectedness. Interacting with one widget can cause others to update and display new information. In conventional complex mashups, it can be difficult for a user to keep track of how interacting with each widget will affect the others in the mashup. Another problem with matchups is that the mashup workspace 24 is often larger than a visible portion shown in a display area or view on a display screen 30.

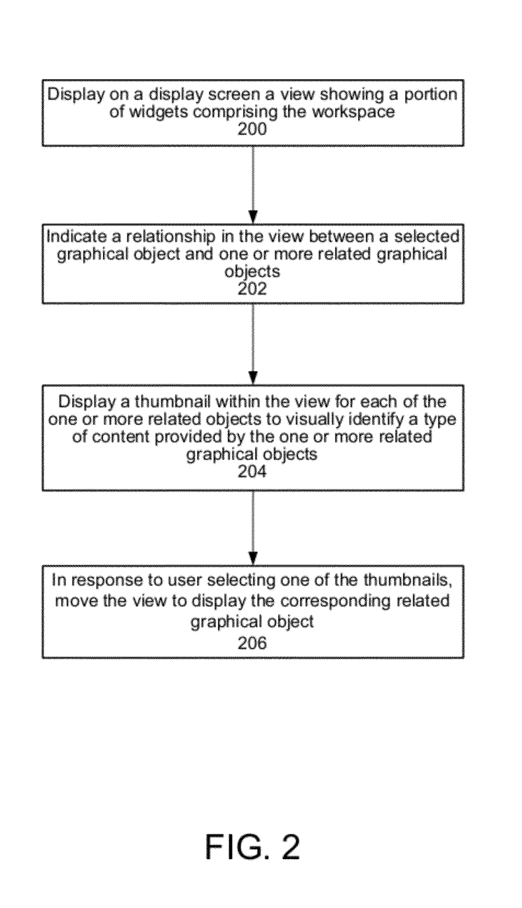

FIG. 2 is a flow diagram illustrating one embodiment of an improved process for displaying graphical objects in mashup. The process may be performed by a software component, such as a mashup program, executing on at least one processor that displays graphical objects in a workspace, wherein the graphical objects may represent data from different data sources. The process may include displaying on the display screen a view showing a portion of graphical objects comprising the workspace (step 200). In one embodiment, the graphical objects comprise widgets, but may include other types of elements, such as dashboard modules or application thumbnails, for example.

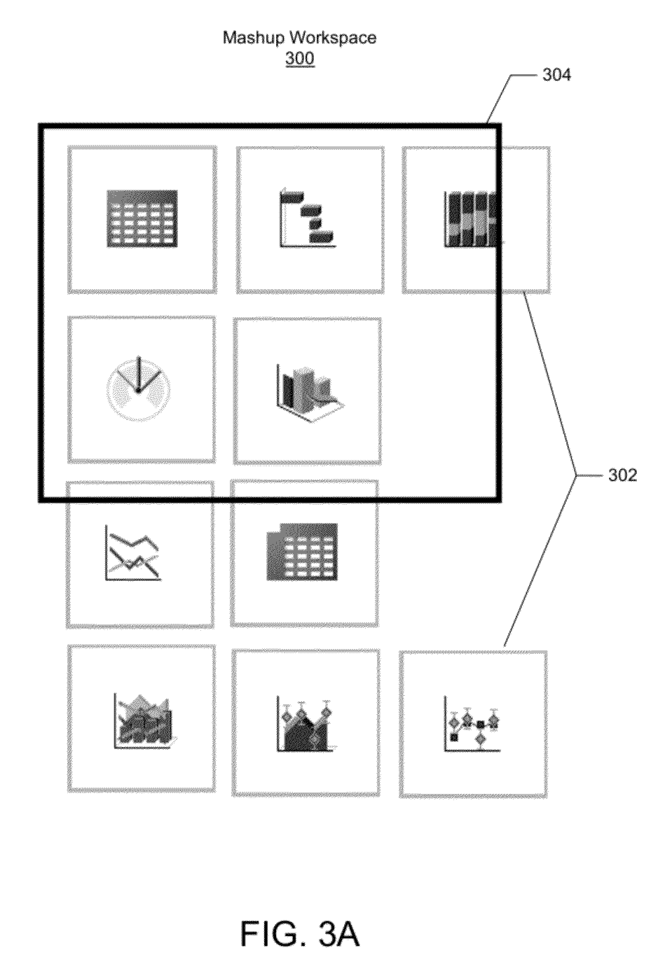

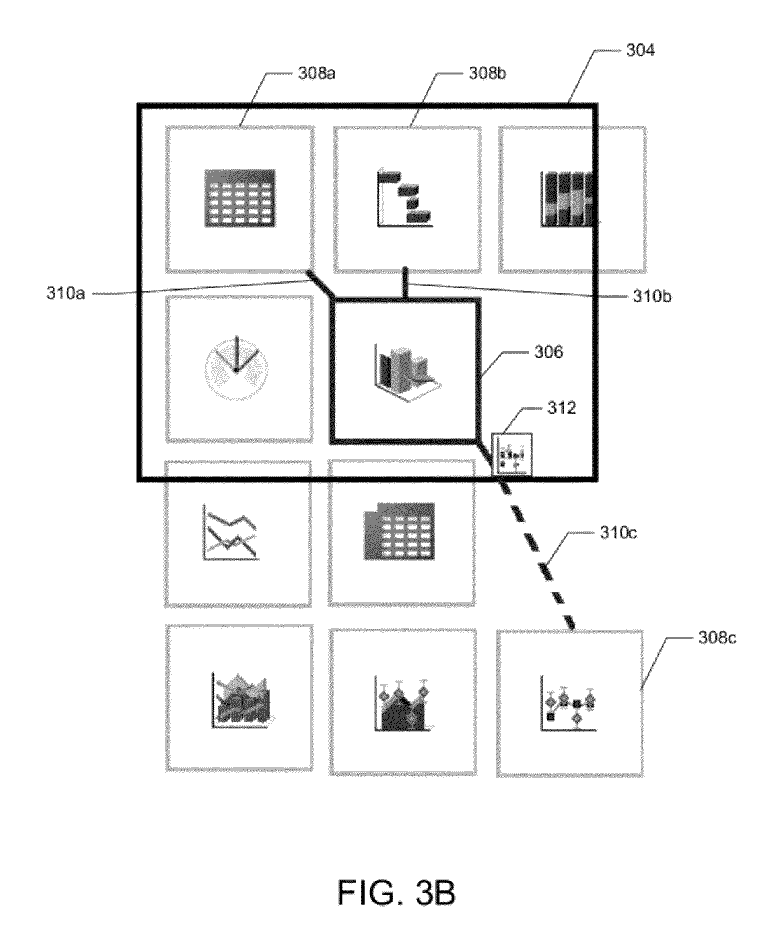

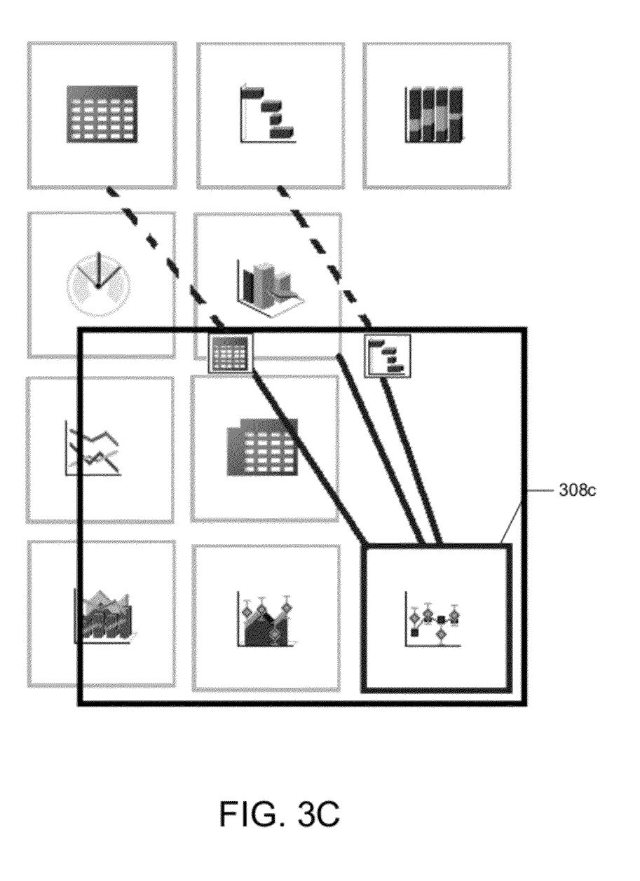

FIG. 3A is a diagram illustrating an exemplary mashup workspace 300. In this embodiment, the mashup workspace 300 comprises a two-dimensional array of graphical objects in the form of widgets 302. A portion of the mashup space 300 is displayed within a display area or view 304 on the display screen 30. The view 304, however, may be sized so that only a portion of the widgets 302 available in the mashup workspace 300 are viewable.

In one embodiment, the widgets 302 may be implemented as frames that hold content that can originate from different data sources. Typically, widgets are not icons, but rather are separate content applications. In one embodiment, the widgets 302 are capable of communicating with one another. To do so, the widgets 302 may register themselves on a channel or against an event.

Referring again to FIG. 2, the mashup program indicates a relationship in the view between a selected graphical object and one or more related graphical objects (step 202). That is, once a user selects one of the graphical objects, the selected graphic object is highlighted and the mashup program determines which graphical objects are related to the selected graphical object. The mashup program then displays screen indications that indicate the graphical objects that are related to the currently selected graphic object.

FIG. 3B is a diagram illustrating the exemplary mashup workspace 300 showing relationships between a selected widget and related widgets. In one embodiment, the relationship indications 310a and 310b are implemented as lines drawn between the selected widget 306 and each of the other related widgets 308a 308b that are viewable. For any of the related widgets 308c that are located out of the view, a relationship indication 310c (e.g., a line) is drawn between the selected widget 306 and an edge of the view 304 that is a direction of the related widget 308c. The dashed portion of the line is not visible but is provided to show the reader which related widget the line is connected to. According to one embodiment, the lines 310 may represent channels or events that the widgets 306 and 308 have in common. Other embodiments for the relationship indicators could include arrows and text for example,

Referring again to FIG. 2, in response to any of the one or more related objects being outside of the view, the program displays a thumbnail within the view for each of the one or more related objects to visually identify a type of content provided by the one or more related objects (step 204). Because a thumbnail is typically a picture of an object, the user is able to see the approximate content of the object and therefore its identity.

As shown in FIG. 3B, a thumbnail 312 for the out-of-view related widget 308c is displayed adjacent to the line between the selected widget 306 and the related widget 308c. In one embodiment, the thumbnails 312 of out-of-view widgets may be displayed adjacent to a border of the view 304 that is closest to the location of the corresponding related widget to indicate to a user the approximate direction of the related object.

The thumbnails of the out-of-view widgets may be implemented in a variety of ways. In one embodiment, the thumbnails may be implemented as a minimized picture of the widget, or as an icon of the widget type. Picture of the widgets may be obtained in a variety of methods. For example some technologies, such as flash, could allow a screen capture of a widget, which could be then reduced in size. Another method would be to configure the mashup program to render another instance of the widget with a smaller floating container. Also the widget could be configured to implement another renderer, and the mashup program could simply invoke that rendering of the widget stead when creating the thumbnail.

Referring again to FIG. 2, in response to user selecting one of the thumbnails, the mashup program moves or scrolls the view to display the corresponding related object (step 206).

FIG. 3C shows that in response to the user selecting or clicking the thumbnail 312 in FIG. 3B, the widgets in the mashup workspace 300 are scrolled such that the previously out-of-view related widget 308c is now displayed in the view 304 as the currently selected widget (shown by the highlighting). The relationships between the selected widget and the other widgets are determined and the view is updated to display the appropriate relationship indications and thumbnails of the out-of-view widgets, as described above.

The process of displaying graphical object relationships in a mashup will now be explained in further detail. In one embodiment, any type of mashup program may be modified or configured to perform the following process. The process may include the mashup program determining which widgets are related to the currently selected widget in the view. Determining which widgets are related may be performed using an internal table of event wiring between widgets, or by analyzing the data in the widgets to determine which of them contain data from the same sources.

The mashup program also marks a currently selected widget in the view. For example, the border of the widget may be highlighted or the widget may be displayed in a different color.

The mashup program then draws a line from the selected widget to each of the related widgets in the view. In one embodiment, the lines are drawn so as not to interfere with other widgets displayed in the view.

The mashup program calculates which of the related widgets are currently out of the view, for the out-of-view related widgets, a line may be drawn from the selected widget as described with respect to step 202 in FIG. 2. For each of the out-of-view related widgets, the mashup program also displays a thumbnail adjacent to the border closest to the corresponding related widget. A tooltip with the related widget name or title may also be made available that is displayed when the corresponding thumbnail is moused over.

In response to user clicking on one of the thumbnails, the mashup program scrolls the view to the widget that the thumbnail represents. This widget is made the currently selected widget, is marked as such such, and lines are drawn to any related widgets as described above.

A method and system for improved process for displaying objects in a workspace has been disclosed. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, JavaScript, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A computer-implemented method performed by a software component executing on at least one processor for displaying graphical objects in a workspace, comprising:
displaying on a display screen a view showing a portion of graphical objects comprising the workspace;
indicating a relationship in the view between a selected graphical object and one or more related graphical objects;
in response to any of the one or more related graphical objects being outside of the view, displaying thumbnails within the view for each of the one or more related graphical objects to visually identify a type of content provided by the one or more related graphical objects; and
in response to a user selecting one of the thumbnails, moving the view to display the corresponding related graphical object.

2. The method of claim 1 wherein the graphical objects comprise at least one of widgets, dashboard modules and application thumbnails, and wherein the workspace comprises a mashup.

3. The method of claim 1 further comprising displaying each of the thumbnails adjacent to a border of the view that is closest to the location of the corresponding related graphical object to indicate to a user an approximate direction of the related graphical object.

4. The method of claim 1 wherein indicating a relationship in the view between a selected graphical object and one or more related graphical objects further comprises: determining which of the graphical objects are related to the selected graphical object.

5. The method of claim 4 further comprising displaying relationship indications to indicate the relationship between the selected graphic object and the related graphical objects.

6. The method of claim 5 further comprising: for any related graphical objects that are located out of the view, drawing the relationship indication between the selected graphical object to an edge of the view that is in a direction of the related graphical object.

7. The method of claim 5 wherein displaying relationship indications further comprises: displaying a line between the selected graphical object and each of the other related graphical objects.

8. The method of claim 1 wherein moving the view to display the corresponding related graphical object further comprises:
displaying the related graphical object as the currently selected graphical object;
determining relationships between the selected graphical object and the other graphical objects; and
updating the view to display relationship indications and thumbnails of the out-of-view graphical objects.

9. An executable software product stored on a computer-readable medium containing program instructions for selecting and presenting a route to a user, the program instructions for:
displaying on a display screen a view showing a portion of graphical objects comprising the workspace;
indicating a relationship in the view between a selected graphical object and one or more related graphical objects;
in response to any of the one or more related graphical objects being outside of the view, displaying thumbnails within the view for each of the one or more related graphical objects to visually identify a type of content provided by the one or more related graphical objects; and
in response to a user selecting one of the thumbnails, moving the view to display the corresponding related graphical object.

10. The computer-readable medium of claim 9 wherein the graphical objects comprise at least one of widgets, dashboard modules and application thumbnails, and wherein the workspace comprises a mashup.

11. The computer-readable medium of claim 9 further comprising program instructions for displaying each of the thumbnails adjacent to a border of the view that is closest to the location of the corresponding related graphical object to indicate to a user an approximate direction of the related graphical object.

12. The computer-readable medium of claim 9 wherein indicating a relationship in the view between a selected graphical object and one or more related graphical objects further comprises: determining which of the graphical objects are related to the selected graphical object.

13. The computer-readable medium of claim 12 further comprising program instructions for displaying relationship indications to indicate the relationship between the selected graphic object and the related graphical objects.

14. The computer-readable medium of claim 13 further comprising program instructions for: for any related graphical objects that are located out of the view, drawing the relationship indication between the selected graphical object to an edge of the view that is in a direction of the related graphical object.

15. The computer-readable medium of claim 13 wherein displaying relationship indications further comprises: displaying a line between the selected graphical object and each of the other related graphical objects.

16. The computer-readable medium of claim 9 wherein moving the view to display the corresponding related graphical object further comprises program instructions for:
displaying the related graphical object as the currently selected graphical object;
determining relationships between the selected graphical object and the other graphical objects; and
updating the view to display relationship indications and thumbnails of the out-of-view graphical objects.

17. A system, comprising:
a memory;
at least one processor coupled to the memory; and
a software component executed by the processor that is configured to:
display on a display screen a view showing a portion of graphical objects comprising the workspace;
indicate a relationship in the view between a selected graphical object and one or more related graphical objects;
in response to any of the one or more related graphical objects being outside of the view, display thumbnails within the view for each of the one or more related graphical objects to visually identify a type of content provided by the one or more related graphical objects; and
in response to a user selecting one of the thumbnails, move the view to display the corresponding related graphical object.

18. The system of claim 17 wherein the graphical objects comprise at least one of widgets, dashboard modules and application thumbnails, and wherein the workspace comprises a mashup.

19. The system of claim 17 wherein the software component displays each of the thumbnails adjacent to a border of the view that is closest to the location of the corresponding related graphical object to indicate to a user an approximate direction of the related graphical object.

20. The system of claim 17 wherein the software component indicates a relationship in the view between a selected graphical object and one or more related graphical objects by determining which of the graphical objects are related to the selected graphical object.

21. The system of claim 20 wherein the software component displays relationship indications to indicate the relationship between the selected graphic object and the related graphical objects.

22. The system of claim 21 wherein for any related graphical objects that are located out of the view, the software component displays the relationship indication between the selected graphical object to an edge of the view that is in a direction of the related graphical object.

23. The system of claim 21 wherein the software component displays relationship indications by displaying a line between the selected graphical object and each of the other related graphical objects.

24. The system of claim 17 wherein in response to moving the view to display the corresponding related graphical object, the software component is configured to:
display the related graphical object as the currently selected graphical object;
determine relationships between the selected graphical object and the other graphical objects; and
update the view to display relationship indications and thumbnails of the out-of-view graphical objects.
